(19) United States
(12) Patent Application Publication
(10) Pub. No.: US 2003/0156825 A1
(43) Pub. Date: Aug. 21, 2003

(54) Method for managing play lists in an optical disk apparatus

(76) Inventors: Soung Hyun Um, Anyang-si (KR); Kang Soo Seo, Anyang (KR); Byung Jin Kim, Sungnam (KR); Jea Yong Yoo, Seoul (KR)

Correspondence Address: BIRCH STEWART KOLASCH & BIRCH, PO BOX 747, FALLS CHURCH, VA, 22040-0747, US

(21) Appl. No.: 10/369,594

(22) Filed: Feb. 21, 2003

(30) Foreign Application Priority Data
Feb. 21, 2002 (KR) 2002-0009357

(51) Int. Cl. H04N 5/783; H04N 5/781

(52) U.S. Cl. 386/69; 386/70; 386/125

(57) ABSTRACT

A method for managing play lists for playback control of data streams recorded on a rewritable optical disk. When a user selects a partial interval of a video or audio clip the total interval of which is referred to by a real play list, a virtual play list that refers to the selected partial interval is created and recorded. If a request for minimizing the clip is received, the intervals that are not referred to by the virtual play list within the clip referred to by the real play list is deleted and the real play list is marked so that the real play list is not displayed as a menu item. When a request for displaying play lists is received from a user, all the play lists except for the real play lists marked as hidden items are displayed on the play list menu screen. As a result, a repeated display of play lists referring to the same clip is prevented and users do not get confused.

### BACKGROUND OF THE INVENTION

1. Field of the Invention

The present invention relates to a method for managing play lists as management information for playback control of data streams recorded on an optical disk such as a rewritable high-density storage medium.

2. Description of the Related Art

A DVD, which is a high-density and high-capacity optical disk, is widely used for storing high-quality moving picture data or audio data. There are several different types of DVDs such as read-only DVD-ROM, one-time recordable DVD-R, and rewritable DVD-RAM or DVD-RW. The standardization of data recording formats for recording moving picture and audio data on a rewritable DVD such as a DVD-RAM and a DVD-RW has been almost completed.

On the other hand, with the start of HD-TV broadcasts the development of rewritable higher-capacity optical disks for recording and reproducing HD-TV broadcasts has been completed. The higher-capacity optical disk has a storage capacity of about 23 GB, 5 times as much as the capacity of a DVD. The development of application specifications for commercializing the higher-capacity storage medium is under way by relevant consumer electronics manufactures.

An optical disk apparatus capable of receiving HD-TV broadcasts and recording received HD contents on a rewritable higher-capacity optical disk having a capacity of 23 GB comprises a DVR recording system 11, an optical pickup 12, and a control unit 13, as shown in FIG. 1.

Receiving a data stream, for example, a video clip, the DVR recording system 11 records the received video clip on the rewritable high-density storage medium 10, creates a play list that refers to the recorded video clip, and records the created play list as management information. Such a play list created when the data is recorded is called a real play list.

A user may select partial intervals of a recorded clip and request the selected intervals to be played. A play list created in response to such a request is called a virtual play list. A virtual play list contains information for referring to each selected interval within a recorded clip.

Once such a virtual play list that refers to selected intervals of a recorded clip is created, users tend to play the recorded clip using the virtual play list. In such a case, the intervals of the clip that are not referred to by the virtual play list are likely to become useless and therefore more storage space can be obtained by deleting the useless intervals. Such a scheme has been proposed in discussions on new disk formats.

In case a recorded clip is partly deleted by such a scheme, a play request using the real play list that refers to the original clip will cause undesired results because the clip is played in such a way that only the user's preferred intervals referred to by the virtual play lists are played and therefore the clip might be discontinuous at the boundary of each preferred interval. As a result, the real play list that refers to the original clip needs special management.

### SUMMARY OF THE INVENTION

It is an object of the present invention to provide a method for editing play lists, wherein after intervals of a data clip stored on a storage medium that are not referred to by virtual play lists are deleted, the real play list referring to the data clip is not displayed in the menu screen so that the movie clip is not selected using the real play list.

The method for managing play lists in an optical disk apparatus in accordance with one embodiment of the invention comprises the two steps of (a) when a user selects a partial interval of a video and/or audio clip the total interval of which is referred to by a first-type play list, creating and recording a second-type play list that refers to the selected partial interval and (b) when a request for minimizing the clip is received, deleting the intervals that are not referred to by the second-type play list within the clip referred to by the first-type play list and marking the first-type play list so that the first-type play list is not displayed as a menu item.

The method for managing play lists in an optical disk apparatus in accordance with another embodiment of the invention comprises (a) when recording a video and/or audio clip on a storage medium, creating and recording a first-type play list that refers to the total interval of the clip and (b) when a user selects a partial interval of the clip, creating and recording a second-type play list that refers to the selected partial interval, the first-type play list including a field for storing a value indicating whether to display the first-type play list as a menu item.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates a brief block diagram of an optical disk apparatus;

FIGS. 2 and 3 are exemplary processes of minimizing a recorded clip; and

FIGS. 4, 5, and 6 are the overall and partial structures of a real play list in accordance with preferred embodiments of the present invention.

### DETAILED DESCRIPTION OF THE PREFFERRED EMBODIMENT

In order that the invention may be fully understood, preferred embodiments thereof will now be described with reference to the accompanying drawings.

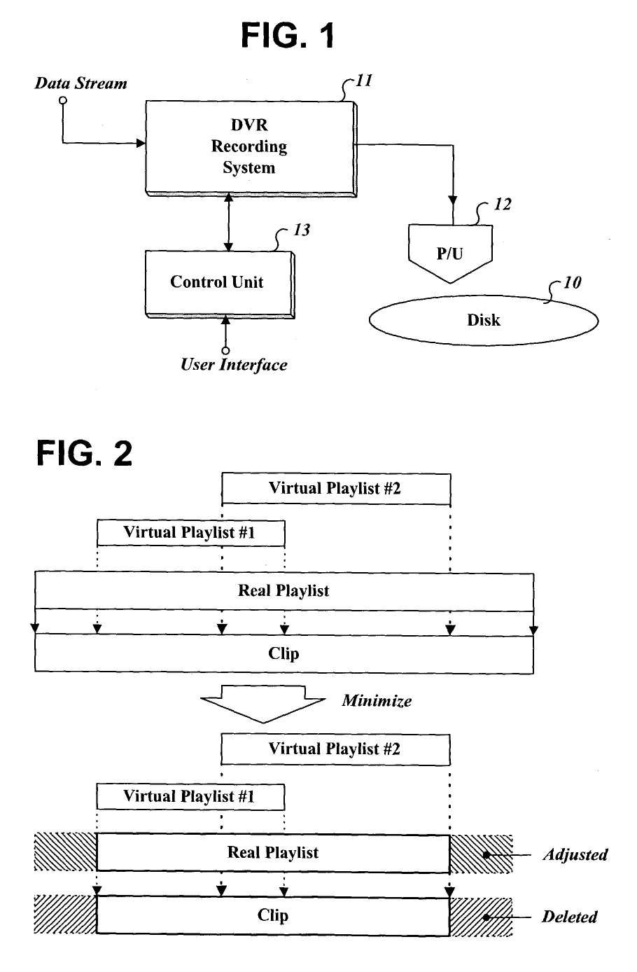

The optical disk apparatus comprising the DVR recording system 11, optical pickup 12, and the control unit 13 as shown in FIG. 1 records an incoming data stream, for example a video and/or audio clip, on the high-density storage medium 10. Along with the data recording, the optical disk apparatus creates a real play list for playback control of the recorded clip and records the created play list on the storage medium as management information.

If a user selects an interval of the recorded clip and sets the interval as a play item, the control unit 13 creates a virtual play list that refers to the selected interval and records the virtual play list in the management information area of the storage medium 10.

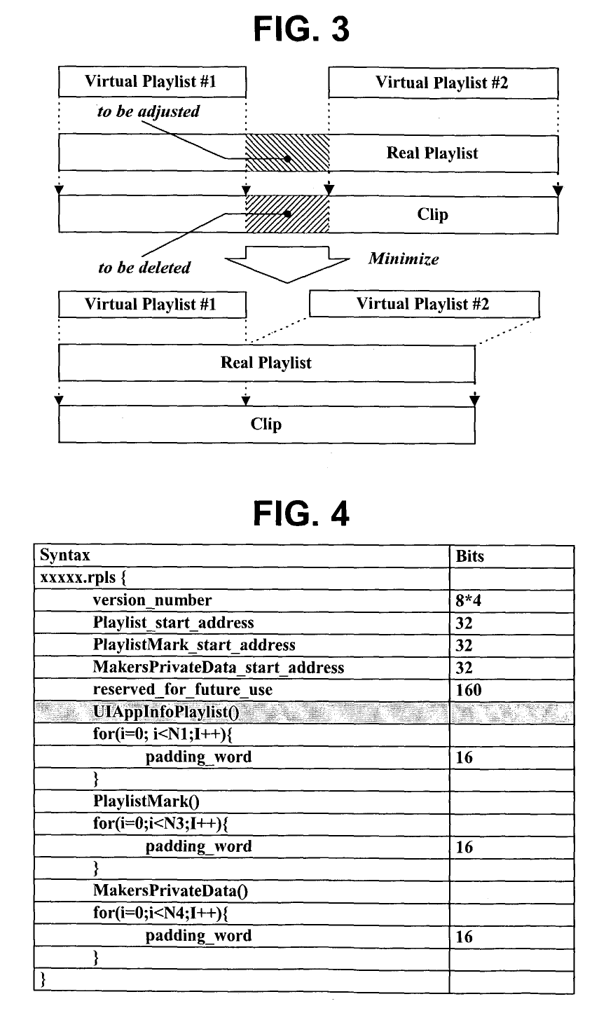

It is possible that more than one virtual play list that refers to a movie clip can be created. FIG. 2 shows two virtual play lists referring to intervals of a recorded movie clip referred to by a real play list.

After selecting preferred intervals of a recorded video clip, a user may issue a command of ‘minimize’ for deleting intervals of the video clip that do not belong to the preferred intervals. The control unit 13, responsive to the command, deletes the data that do not belong to the preferred intervals and modifies the real play list referring to the video clip. The modification is done in such a way that more than one play item belonging to a play list is adjusted or play items are divided or deleted.

FIGS. 2 and 3 show two exemplary minimization processes. In FIG. 2, starting and ending parts of a movie clip are deleted, whereas in FIG. 3 a middle part of a movie clip is deleted.

The real play list created when the clip is recorded on the storage medium has additional flag information for indicating that the referenced clip is minimized or hidden in the menu screen.

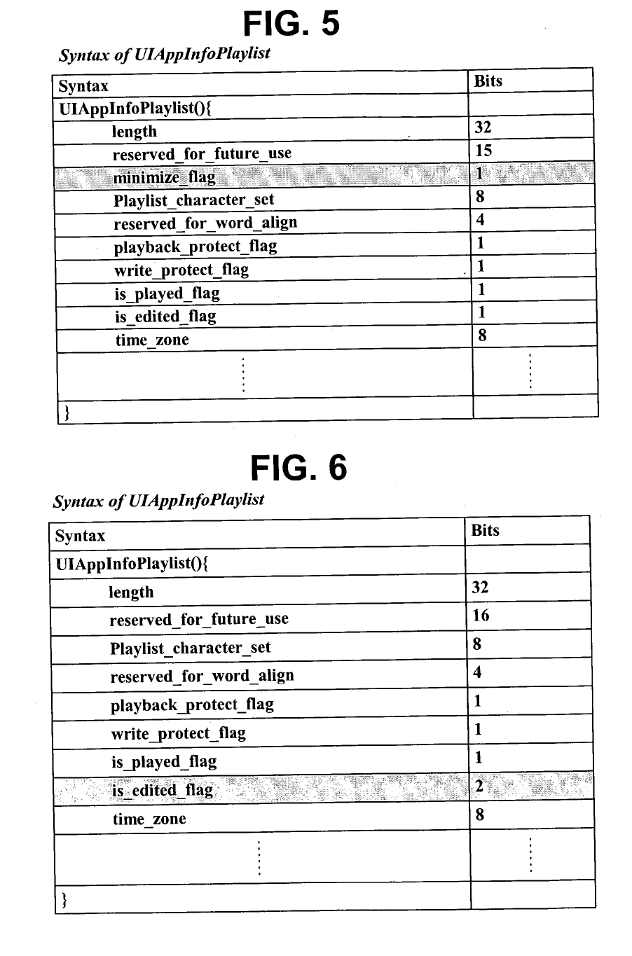

The flag information is recorded in the user interface application information play list (UIAppInfoPlayList) table in the real play list shown in FIG. 4.

The real play list shown in FIG. 4 includes the fields of a version number (version_number), a play list start address (PlayList_start_address), a play list mark start address (PlayListMark_start_address), a maker's private data start address (MakersPrivateData_start_address), and the user interface application information play list (UIAppInfoPlayList) table.

As shown in FIG. 5, the user interface application information play list (UIAppInfoPlayList) table includes the fields of a data length (Length), a play list character set (PlayList_character_set), a playback protect flag (playback_protect_flag), and a 1-bit flag (minimize_flag) for indicating whether the associated clip is minimized.

The 1-bit flag of minimize_flag can be stored in a 16-bit field reserved for future use (reserved_for_futer_use). The 1-bit flag is initialized to ‘0’ when the real play list is created.

The control unit 13, responsive to a user command of ‘minimize’, performs a required action on the associated clip as shown in FIG. 2 or FIG. 3 and sets the minimize_flag of the real play list that refers to the minimized clip to ‘1’.

If a user requests the display of the menu screen to play a particular clip after such a process has been done, the control unit 13 displays every virtual play list on the screen and examines the value of the minimize_flag of each of the real play lists. If the value of a real play list is ‘0’, the real play list is displayed as a selectable item on the menu screen, and otherwise the real play is not displayed on the menu screen.

If a user requests unconditional display of every play list, that is, display of hidden play lists as well, the control unit 13 may display every real and virtual play list on the menu screen without regard to the value of the minimize_flag.

Instead of using an additional flag, the 1-bit flag of is_edited_flag contained in the real play list shown in FIG. 6 can be extended to 2 bits and used to indicate whether the associated clip is minimized.

For example, if the value of the 2-bit flag, is_edited_flag, is ‘00’, it indicates the associated clip is not edited. If the value is ‘01’, it indicates the associated clip is edited in a general sense. If the value is ‘10’, it indicates the associated clip is minimized, in which case the control unit 13 does not display the real play list that refers to the clip on the menu screen.

The method for managing play lists in an optical disk apparatus in accordance with the present invention eliminates a repeated display of play lists that refers to the same video and/or audio clip intervals, thereby preventing checking of unnecessary play lists and possible confusion about play lists.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method for managing play lists in an optical disk apparatus, comprising the steps of:
(a) creating and recording, when a user selects a partial interval of a video and/or audio clip the total interval of which is referred to by a first-type play list, a second-type play list that refers to the selected partial interval; and
(b) deleting, when a request for minimizing said clip is received, the intervals that are not referred to by said second-type play list within said clip referred to by said first-type play list, and marking said first-type play list so that said first-type play list is not displayed as a menu item.

2. The method of claim 1, wherein said step (b) sets the value of an indicator pertaining to said first-type play list to ‘hidden’, the indicator used for indicating whether said first-type play list is displayed as a menu item.

3. The method of claim 2, wherein said indicator is a 1-bit flag.

4. The method of claim 2, wherein said indicator is information of at least 2 bits for also indicating whether said clip has been edited.

5. The method of claim 2, wherein said indicator is stored in an information field related to user interface of said first-type play list.

6. The method of claim 1, further comprising the step of: displaying, when a request for displaying play lists is received from a user, all play lists except for first-type play lists marked as hidden items on the play list menu screen.

7. A method for managing play lists in an optical disk apparatus, comprising the steps of:
(a) creating and recording, when recording a video and/or audio clip on a storage medium, a first-type play list that refers to the total interval of the clip; and
(b) creating and recording, when a user selects a partial interval of said clip, a second-type play list that refers to the selected partial interval, said first-type play list including a field for storing a value indicating whether to display said first-type play list as a menu item.

8. The method of claim 7, wherein said field is a 1-bit flag.

9. The method of claim 7, wherein said field is of at least 2 bits for also indicating whether said clip has been edited.

10. The method of claim 7, wherein said field is stored in an information area related to user interface of said first-type play list.

11. The method of claim 7, further comprising the step of: displaying, when a request for displaying play lists is received from a user, all play lists except for first-type play lists marked as hidden items on the play list menu screen.
